(19) United States
(12) Patent Application Publication
(10) Pub. No.: US 2026/0173079 A1
(43) Pub. Date: Jun. 18, 2026

(54) TIMING ADVANCE OPTIMIZATION DURING UPLINK SYNCHRONIZATION

(71) Applicant: RAKUTEN SYMPHONY INC., Tokyo (JP)

(72) Inventors: Subramanya CHANDRASHEKAR, Karnataka (IN); Raghavendra Madanahally RAMAKRISHNA, Karnataka (IN)

(73) Assignee: RAKUTEN SYMPHONY INC., Tokyo (JP)

(21) Appl. No.: 18/714,421

(22) PCT Filed: Mar. 28, 2024
(86) PCT No.: PCT/US2024/021836

§ 371 Date: May 29, 2024

(30) Foreign Application Priority Data
Mar. 31, 2023 (IN) 202341024646
Nov. 30, 2023 (IN) 202341024646

(51) Int. Cl. H04W 72/21; H04W 16/28; H04W 56/00; H04W 72/0453; H04W 72/23; H04W 74/0833

(52) U.S. Cl. CPC H04W 72/21; H04W 16/28; H04W 56/0045; H04W 72/0453; H04W 72/23; H04W 74/0833

(57) ABSTRACT

Embodiments disclosed herein provide a method and system for performing TA optimization during uplink synchronization. A request is received, at a User Equipment (UE) 102 from a first distributed unit (DU) of a serving base station 104 to perform an uplink synchronization with a candidate cell of a second DU of target base station 106A, 106B, Further, the uplink synchronization is performed by the UE 102 with the second DU. Furthermore, the UE 102 receives a primary beam identifier and secondary beam identifiers with associated with associated timing advance TAs from the second DU based on the uplink synchronization. Accordingly, the UE 102 may determine a target beam of a target cell and perform a serving cell switch function to the target beam.

### CROSS-REFERENCE TO RELATED APPLICATIONS

This application claims the benefit of Provisional Indian Patent Application No. 202341024646, filed on Mar. 31, 2023, the full disclosure of which is incorporated herein by reference in its entireties for all purposes.

### TECHNICAL FIELD

The present disclosure generally relates to the field of wireless communication, and more particularly relates to timing advance optimization during Uplink (UL) synchronization.

### BACKGROUND

A cellular network is a telecommunication interconnection of user devices and cellular Base Station (BS), such as cell tower. A BS includes a service area which is divided into a plurality of cells. A cell defines a geographical area which is served by a transceiver antenna associated with the BS. Multiple user devices present in a particular cell, also referred as serving cell, communicate with the associated transceiver antenna of the BS on a plurality of frequencies and frequency channels.

A Radio Access Network (RAN) is part of the cellular network and is responsible for implementing radio access technology. RANs provide connection to user devices, such as a mobile phone/device, a computer, or any remotely controlled device present in the network, with a Core Network (CN). The user devices may be varyingly known as User Equipment (UE), terminal equipment, Mobile Station (MS), and the like.

While a mobile device, such as a UE, is connected to the serving cell, the mobile device performs measurements of channel parameters and signal parameters related to the serving cell as well as neighbouring cells for a predefined time period. Additionally, when multiple UEs are connected to the serving cell, a distance between the serving BS and the UE is derived through measurements of the time elapsed for radio waves to travel from the UE to the serving BS, known as Timing Advance (TA). Further, the value of the TA may be affected due to the change in the distance between the UE and the serving BS due to the movement of the UE. Similarly, at least one of the neighbouring cells may have an associated TA with respect to the UEs served in the neighbouring cells.

During the movement of the mobile device, the TA, the channel parameters, and the signal parameters related to the serving cell and the neighbouring cells constantly change. For example, if the UE is moving from the coverage area of the serving cell to the coverage area of one of the neighbouring cells, also referred to as target cell, the UE needs to connect to the neighbouring cell and disconnect from the serving cell. This procedure is known as handover (HO). The above-mentioned UE mobility, defining the UE movement, may be referred to as Layer 1 (L1)/Layer 2 (L2) centric inter-cell mobility (LTM). However, it should be understood that the UE mobility may also be realized in a manner alternate to LTM, not discussed herein for the sake of brevity. In LTM, based on the UE movement and in order to perform handover from the serving cell to the target cell, the UE is required to obtain the knowledge of the TA related to the target cell for implementing the same and to continue communicating with the target cell. The knowledge of the TA is necessary for the UE to perform proper synchronization, also referred to as UL synchronization, and connection with the target cell.

In a conventional technique, a disaggregated BS architecture is defined for cellular network. For example, a disaggregated Next Generation Node B (gNB) architecture is defined in 3rd Generation Partnership Project (3GPP) decomposing a gNB into multiple logical entities. For example, the gNB may include a gNB-Control Unit-Control Plane (CU-CP) and the gNB Distributed Unit (DU). Likewise, a single DU may be responsible to host multiple cells. As an example, a single DU may be responsible to host a maximum of 512 cells in current 3GPP specifications. The gNB-CU-CP may host a Packet Data Convergence Protocol (PDCP) and a Radio Resource Control (RRC) layer, while the gNB-DU hosts a Radio Link Control (RLC), a Medium Access Control (MAC), and a Physical (PHY) layer. Further, a downlink (DL) scheduling operation may take place at the gNB-DU. In order to support Layer 1 (L1)/Layer 2 (L2) centric inter-cell mobility, related to the changing of serving cell, in the disaggregated gNB architecture, a mechanism is required in which the handover preparation is performed by the gNB-CU-CP, but handover is executed autonomously by the gNB-DU without further interaction with upper layers, such as PDCP and the RRC layer. The handover preparation may also be referred as target cell configuration preparation. For example, the handover without further interaction with the upper layers may be Random Access Channel (RACH)-less L1/L2 triggered mobility (LTM) Handover (HO).

3GPP Release 18 Work Item (WI) describes further New Radio (NR) mobility enhancements as described below:
Short name: NR_Mob_enh2-Core;
leading WG: RAN2;
3GPP Release: REL-18;
Work item description: RP-221799
The objectives of the upcoming mobility enhancement Rel. 18 work item can be found in RP-213565:
   To specify mechanism and procedures of L1/L2 based inter-cell mobility for mobility latency reduction:
      Configuration and maintenance for multiple candidate cells to allow fast application of configurations for candidate cells [RAN2, RAN3]
      Dynamic switch mechanism among candidate serving cells (including SpCell and SCell) for the potential applicable scenarios based on L1/L2 signalling [RAN2, RAN1]
      L1 enhancements for inter-cell beam management, including L1 measurement and reporting, and beam indication [RAN1, RAN2]
   Note 1: Early RAN2 involvement is necessary, including the possibility of further clarifying the interaction between this bullet with the previous bullet.
      Timing Advance management [RAN1, RAN2]
      CU-DU interface signaling to support L1/L2 mobility, if needed [RAN3]
   Note 2: FR2 specific enhancements are not precluded, if any.
   Note 3: The procedure of L1/L2 based inter-cell mobility are applicable to the following scenarios:
   Standalone, CA and NR-DC case with serving cell change within one CG.
   Intra-DU case and intra-CU inter-DU case (applicable for Standalone and CA: no new RAN interfaces are expected)
   Both intra-frequency and inter-frequency
   Both FR1 and FR2
   Source and target cells may be synchronized or non-synchronized.
   Notes: L1/L2 triggered mobility is a mobility feature and can be considered a basic UE capability (starting R18).

In accordance with the conventional technique, following are the agreements in RAN1 from the RAN1 #112 meeting:
For PDCCH ordered-RACH for candidate cell(s), RAR reception can be configured/indicated.
   If reception of RAR is not configured/indicated (without RAR)
      TA value of candidate cell is indicated in cell switch command.
      FFS: whether UE should re-transmit PRACH when reception of RAR is not configured/indicated
      FFS: how UE determine the transmit power of subsequent PRACH triggered by PDCCH order
   If reception of RAR is configured/indicated (with RAR), FFS
      whether RAR is received from-serving cell or candidate cell
         if RAR is received from candidate cell, whether Type1-PDCCH CSS of the candidate cell is configured to the UE.
      content of RAR
   FFS: signaling for configuration/indication of whether RAR needs to be received
   UE can report the support combination of with RAR only and without RAR only, where support of one default scheme is the baseline UE approach for LTM.
   Send LS to RAN2 and RAN3 to check the feasibility about this agreement.
Note: Definition of candidate cells is up to RAN2

### Agreement

If reception of RAR is configured/indicated, RAR contains at least TA of candidate cell.
   The maximum number of TA values memorized by UE is a UE capability.
   FFS: whether other parameters such as UE ID, candidate cell ID etc. is contained in RAR

In the conventional technique, acquiring the target cell TA prior to the serving cell switch, reduces handover latency during an LTM Serving Cell Change (SCC) (also referred hereinafter as Serving Cell Switch), as the TA is already known to the UE and, thus, obtaining the TA can be avoided during the actual SCC. During the LTM, if a UE is configured to perform UL synchronization process, a time window exists between acquiring the target cell TA and execution of the LTM SCC. The time duration may vary from one UE to another UE and even for the same UE on different occasions. Thus, the time duration may not be accurately determined or predicted.

As the UE may undergo mobility during this time duration, as a result the UE's TA at the target cell also undergoes a change. For example, the TA acquired during the UL synchronization process may not be valid at the time of the LTM SCC. Thus, in order to obtain a valid TA at the time of the LTM SCC and to ensure RACH-less LTM Handover, a serving gNB-DU requests the UE to perform the repeated UL synchronization with a target gNB-DU to acquire the updated TA. However, performing the UL synchronization again to acquire the updated TA impacts UE's data transmission at the serving gNB-DU as well as causing an overhead for the target gNB-DU. Alternatively, the serving gNB may request the UE to perform a RACH-based handover at the time of issuing a LTM SCC command, which involves further interaction with upper layers.

Therefore, there is a need for a technique to perform RACH-less handover without the requirement of repeating UL synchronization when a UE undergoes mobility.

The information disclosed in this background of the disclosure section is only for enhancement of understanding of the general background of the disclosure and should not be taken as an acknowledgment or any form of suggestion that this information forms prior art already known to a person skilled in the art.

### SUMMARY

The present disclosure relates to an apparatus configured to receive, at a User Equipment (UE) from a first distributed unit (DU) of a serving base station, a request to perform an uplink synchronization with a candidate cell of a second DU of a target base station. Further, the apparatus is configured to perform, by the UE, the uplink synchronization by sending a Random Access Channel (RACH) request message to the second DU. Furthermore, the apparatus receives from at least one of the first DU and the second DU by the UE, and based on the uplink synchronization, a primary beam identifier of a primary candidate cell of the second DU, with associated primary timing advance (TA), and one or more secondary beam identifiers of at least one of the primary candidate cell and one or more secondary candidate cells of the second DU with associated one or more secondary TAs. The apparatus further receives, by the UE, a cell switch command from the first DU indicating a target beam of a target cell, wherein the target cell is selected from the primary candidate cell or the one or more secondary candidate cells. The apparatus is further configured to perform, by the UE, a serving cell switch function to the target beam and apply a corresponding TA associated with the target beam.

The present disclosure also relates to a method for wireless communication at a User Equipment (UE). The method comprises receiving, from a first distribution unit (DU) of a serving base station, a request to perform an uplink synchronization with a second DU of a target base station. Further, the method comprises performing the uplink synchronization by sending a Random Access Channel (RACH) request message to the second DU. Furthermore, the method comprises receiving, from at least one of the first DU and the second DU based on the uplink synchronization, a primary beam identifier of the second DU, with associated primary TA, and one or more secondary beam identifiers of at least one of the primary candidate cell and one or more secondary candidate cells of the second DU with associated one or more secondary TAs. Moreover, the method comprises receiving a cell switch command from the first DU indicating a target beam of a target cell. The target cell is selected from the primary candidate cell or the one or more secondary candidate cells. The method further comprises performing a serving cell switch function to the target beam and applying a corresponding TA associated with the target beam.

Further, the present disclosure relates to an apparatus configured to determine, at a serving base station and at a first distributed unit (DU) of the serving base station, a candidate cell of a target base station from one or more DUs of one or more candidate base stations, based on one or more signal and channel parameters of a plurality of candidate cells of one or more neighbouring base stations. Further, the apparatus is configured to transmit, from the serving base station, a request, to a User Equipment (UE), to perform uplink synchronization with the candidate cell. Furthermore, the apparatus is configured to receive, at the serving base station and from at least one of the UE and a second DU of the target base station, a primary beam identifier of a primary candidate cell of the second DU with an associated primary timing advance (TA), and one or more secondary beam identifiers of at least one of the primary candidate cell and one or more secondary candidate cells of the second DU with an associated one or more secondary TAs, the primary beam identifier, the primary TA, the one or more secondary beam identifiers, and the one or more secondary TAs being received by the UE from the the second DU based on the uplink synchronization. Moreover, the apparatus is configured to determine, at the serving base station, a target beam of a target cell from the primary beam identifier and the one or more secondary beam identifiers based on associated one or more signal and channel parameters. The apparatus is further configured to transmit a request, from the serving base station and to the UE to perform serving cell switch function to the target beam and apply a corresponding TA associated with the target beam.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The novel features and characteristics of the disclosure are set forth in the appended claims. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates a schematic representation of a random-access resource configuration for a UE, according to the embodiments as disclosed herein;

FIG. 2 is a sequence diagram illustrating a scenario in which an optimal beam belonging to a target gNB-DU is determined and corresponding TA provided by the target gNB-DU is applied, according to the embodiments as disclosed herein;

FIG. 3 is a sequence diagram illustrating another scenario in which an optimal beam belonging to a target gNB-DU is determined and corresponding TA provided by the target gNB-DU is applied, according to the embodiments as disclosed herein;

FIG. 4 illustrates a flowchart of a method for wireless communication at a UE, according to the embodiments as disclosed herein; and

FIG. 5 illustrates a detailed block diagram of an apparatus wherein the method for wireless communication may be implemented, according to the embodiments as disclosed herein.

It should be appreciated by those skilled in the art that any block diagram herein represents conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION OF THE DISCLOSURE

It is to be understood that the present disclosure may assume various alternative variations and step sequences, except where expressly specified to the contrary. It is also to be understood that the specific devices and processes illustrated in the attached drawings and described in the following specification are simply exemplary and non-limiting embodiments or aspects. Hence, specific dimensions and other physical characteristics related to the embodiments or aspects disclosed herein are not to be considered as limiting.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however, that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms “an embodiment”, “embodiment”, “embodiments”, “the embodiment”, “the embodiments”, “one or more embodiments”, “some embodiments”, and “one embodiment” mean “one or more (but not all) embodiments of the present disclosure” unless expressly specified otherwise.

The terms “including”, “comprising”, “having” and variations thereof mean “including but not limited to” unless expressly specified otherwise.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Embodiments disclosed herein provide a method and system for acquiring timing advance during UL synchronization and performing optimization to ensure the acquired TA is valid and applicable for a longer duration. A UE sends L1 measurement report (MR) to a serving gNB-DU for configured cells. The serving gNB-DU checks a set Radio Resource Management (RRM) criteria (for example, predefined Reference Signal Received Power (RSRP) threshold) and requests the UE to perform the UL synchronization using a configured Physical Random-Access Channel (PRACH) preamble, with one or more candidate/target cells. The serving gNB-DU uses a Physical Downlink Control Channel (PDCCH) order to request the UE to perform the UL synchronization. The UE performs the UL synchronization and is configured to receive Random Access Response (RAR) from a target gNB-DU which includes a candidate/target cell timing advance to be used by the UE.

In an embodiment, the target gNB-DU includes UE's TA of neighbouring beams in addition to UE's TA of an optimal beam at the candidate/target cell gNB-DU with RAR. This ensures that the UE applies the corresponding TA when one of the neighbouring beam becomes the optimal beam. The neighbouring beams are qualified as any adjacent beam which is anticipated to be accessed by the UE subsequently (i.e., any beam which the UE is expected to move towards with good radio condition).

In an embodiment, the UE, after acquiring the target cell TA during the UL sync procedure, reports the TA of the optimal beam and the neighbouring beams to the serving gNB-DU and at the time of LTM cell switch, the serving gNB-DU indicates the target cell beam to be used by the UE in the serving cell switch command (Downlink Media Access Control-Control Element (DL MAC CE)) and the command is sent to the UE. The UE uses the TA (provided by the candidate/target gNB-DU) corresponding to the beam indicated during the serving cell switch. Alternatively, the UE is autonomously configured to determine the optimal beam belonging to the candidate/target gNB-DU (based on L1 measurements) and apply the corresponding TA (provided by candidate/target gNB-DU). In this alternative, the serving gNB-DU may not provide the target beam Id. Therefore, the proposed method is used to achieve RACH-less HO even with UE mobility post UL synchronization, change of the optimal beam and better TA estimation.

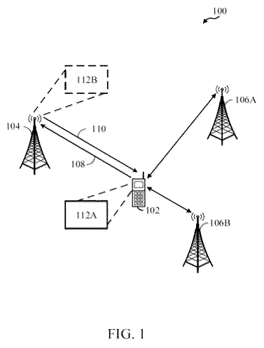

FIG. 1 illustrates a schematic representation 100 of a RAR configuration for a UE 102, according to the embodiments as disclosed herein. The UE 102 may be in communication with a serving cell 104 (also referred hereinafter as the serving base station 104 or the serving gNB-Distributed Unit (DU) 104 as the serving gNB-DU 104 may include one or more serving cell 104). For PDCCH ordered RACH for candidate cell(s) 106A, 106B (also referred hereinafter as the target base station 106A, 106B or the target/candidate gNB-DU 106A, 106B as the target/candidate gNB-DU 106A, 106B may include one or more target/candidate cell 106A, 106B), the RAR reception is configured/indicated. The RAR configuration may be received at the UE 102 and the RAR may be received either from candidate/target cell 106A, 106B or serving cell 104. In an embodiment, in case of absence of configuration or indication of the reception of the RAR, TA value of candidate cell may be indicated in the cell switch command. In another embodiment, when reception of the RAR is configured/indicated and received from the candidate cell 106A, 106B, at least TA may be included in the RAR.

In a conventional disaggregated gNB architecture, a conventional gNB may be decomposed into multiple logical entities, as defined in 3GPP. For example, the conventional gNB may include a gNB-Control Unit-Control Plane (CU-CP) (gNB-Control Unit-Control Plane (CU-CP) is also referred hereinafter as gNB-Centralized Unit (CU) for the sake of brevity) and the gNB DU. Likewise, a single DU may be responsible to host multiple cells. As an example, a single DU may be responsible to host a maximum of 512 cells in current 3GPP specifications. The gNB-CU-CP may host a Packet Data Convergence Protocol (PDCP) and a Radio Resource Control (RRC) layer, while the gNB-DU hosts a Radio Link Control (RLC), a Medium Access Control (MAC), and a Physical (PHY) layer. The scheduling operation takes place at the gNB-DU. In order to support L1/L2 centric inter-cell change, related to the changing of serving cell, in the disaggregated gNB architecture, a mechanism is implemented in which scheduling operation/configuration would take place at the gNB-CU-CP, but executed autonomously by the gNB-DU without any further interaction with the upper layers. For example, the mechanism involves performing the handover preparation by the gNB-CU-CP, but autonomously executing the handover by the gNB-DU without further interaction with upper layers, such as PDCP and the RRC layer.

In an embodiment, at link 108, the UE 102 may send a target cell RSRP MR via link 108 to the serving cell 104. In an embodiment, at link 110, the serving cell 104 may configure the UE 102 using the PDCCH order to perform UL synchronization by sending the PRACH preamble, so that the UE 102 acquires the target cell TA.

In operation, the UE 102 may be configured to transmit to a first distributed unit (DU) of the serving base station 104, a measurement report (MR) associated with respective one or more signal and channel parameters of a plurality of candidate cells 106A, 106B of one or more neighbouring base stations. In an example, the UE 102 may be configured to transmit, to the first DU, L1 MR associated with respective one or more signal and channel parameters of the plurality of candidate cells 106A, 106B associated with the first DU and one or more DUs associated with one or more neighbouring base stations. In an embodiment, the UE 102 may send Layer 1 (L1) MR to the serving gNB-DU 104 for the plurality of candidate cells 106A, 106B. In an example, the plurality of candidate cells may include a plurality of non-serving cells. In an example, the UE 102 may send the MR based on UE's specification and compatibility defining UE's capability, with RAR only and without RAR only, where support of one default scheme may be a baseline UE 102 approach for the LTM. In an example, a maximum number of TA values that the UE 102 may be configured to memorize, may define the UE's capability.

Further, upon sharing the MR to the serving base station 104, the first DU of the serving base station 104 may determine a candidate cell of a target base station 106A, 106B from one or more DUs of one or more candidate base stations. NOTE: The candidate cell could belong to the same base station as the serving cell as well. In an embodiment, the target bases station may be the serving base station. In another embodiment, the determination of the candidate cell may be based on one or more signal and channel parameters of a plurality of candidate cells of the one or more neighbouring base stations. In an embodiment, upon receiving the MR, the serving gNB-DU 104 may check the set RRM criteria. In an example, the RRM criteria may be a predefined RSRP threshold. Based on the determination of the target base station 106A, 106B, the first DU may transmit a request, to the UE, to perform uplink synchronization with the determined candidate cell.

Accordingly, the UE 102 may receive a request from the first DU of the serving base station 104 to perform the uplink synchronization with the candidate cell of a second DU associated with the target base station 106A, 106B. In an example, the first DU of the serving base station 104 may transmit the request to perform the uplink synchronization to the UE 102 using a PDCCH order. Further, the UE 102 may perform the uplink synchronization by sending a Random Access Channel (RACH) request message to the second DU. In an embodiment, in response to performing the uplink synchronization, the UE 102 may be configured to receive, from one of the first DU and the second DU, a Random-Access Response (RAR). For example, the RAR may include at least the primary beam identifier of a primary candidate cell of the second DU with the associated primary TA, and one or more secondary beam identifiers of at least one of the primary candidate cell and one or more secondary candidate cells of the second DU with one or more associated secondary TAs. The secondary beam identifiers may be determined or selected based on respective signal quality metrics. For another example, the UE 102 may be configured to receive the RAR as a subsequent message received from the target base station 106A, 106B. The RAR may include at least the primary beam identifier with the associated primary TA, and one or more secondary beam identifiers with one or more associated secondary TAs.

In an embodiment, based on the uplink synchronization, the UE 102 may receive from the target base station 106A, 106B, a primary beam identifier of the target base station 106A, 106B, with associated primary timing advance (TA). Additionally, the UE 102 may also receive one or more secondary beam identifiers of the target base station 106A, 106B with associated one or more secondary TAs. In an alternative embodiment, the first DU of the serving base station 104 may receive the primary beam identifier of the primary candidate cell of the second DU with an associated primary TA, and the one or more secondary beam identifiers of the one or more secondary candidate cells of the second DU with an associated one or more secondary TAs, from one of the UE 102 and the second DU of the target base station 106A, 106B.

In an embodiment, the UE 102 may include an optimal beam determination module 112A. The UE 102 may utilize the optimal beam determination module 112A to determine an optimal beam from the primary beam identifier and one or more secondary beam identifiers and define the optimal beam as the target beam. In an embodiment, the optimal beam determination module 112A determines the optimal beam based on comparison between one or more signal and channel parameters associated with the primary beam identifier with corresponding one or more signal and channel parameters associated with at least one of the secondary beam identifiers. Based on the comparison, the optimal beam determination module 112A may determine the target beam from the primary beam identifier and the one or more secondary beam identifiers. Further, the UE 102 may perform a serving cell switch function to the target beam and apply a corresponding TA associated with the target beam.

In another embodiment, the UE 102 may transmit to the serving base station 104, the primary beam identifier of the target base station 106A, 106B with an associated primary timing advance (TA), and one or more secondary beam identifiers of the target base station 106A, 106B with an associated one or more secondary TAs. In an example, the serving base station 104 may include the optimal beam determination module 112B. Thereafter, the serving base station 104 may utilize the optimal beam determination module 112B to determine an optimal beam from the primary beam identifier and the one or more secondary beam identifiers based on associated one or more signal and channel parameters and define the optimal beam as the target beam. In an example, to determine the optimal beam, the serving base station 104 may be configured to compare one or more signal and channel parameters associated with the primary beam identifier with corresponding one or more signal and channel parameters associated with at least one of the secondary beam identifiers. In an embodiment, serving base station 104 may be configured to determine, at the first DU of the serving base station 104, a candidate cell of the target base station 106A, 106B from one or more DUs of one or more candidate base stations, based on one or more signal and channel parameters of a plurality of candidate cells of one or more neighbouring base stations. The serving and target base stations could be the same base station as well. Further, the serving base station 104 may be configured to determine the target beam from the primary beam identifier and the one or more secondary beam identifiers based on the comparison result.

In an example, the optimal beam may be defined as the beam having an optimal TA at a particular period of time. Therefore, by including TA of the neighbouring beams along with the target beam, it is ensured that the UE 102 applies the corresponding TA when any of the neighbouring beams becomes the optimal beam. The neighbouring beams may qualify as any adjacent beam that can be anticipated to be accessed by the UE 102 subsequently. For example, the neighbouring beams are beams which the UE 102 can be expected to move towards and having optimal channel and signal characteristics.

Subsequently, the serving base station 104 may request the UE 102 to perform serving cell switch function to the target beam based on a corresponding TA associated with the target beam. In an example, the first DU may transmit a cell switch command to the UE 102 indicating a target beam of a target cell. In an example, the cell switch command may be a Layer 1/Layer 2 Triggered Mobility (LTM) cell switch command. In an example, the target cell may be selected from the primary candidate cell or the one or more secondary candidate cells.

Subsequently, the serving gNB-DU 104 may request the UE 102 to perform UL synchronization using the configured PRACH preamble, with one or more target cells 106A, 106B. The UE 102 may perform the UL synchronization and receive RAR from the target gNB-DU 106A, 106B which includes the candidate/target cell TA to be used by the UE 102. Accordingly, the UE 102 may use the candidate/target cell TA to perform RACH-less LTM handover.

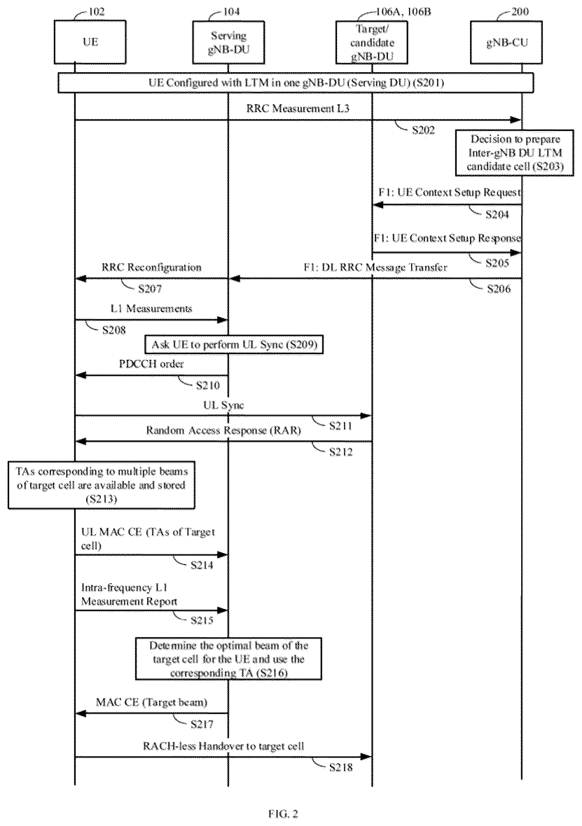

FIG. 2 is a sequence diagram illustrating a scenario in which the UE 102 determines an optimal beam belonging to the target gNB-DU 106A, 106B (based on L1 measurements) and applies the corresponding TA provided by the target gNB-DU 106A, 106B, according to the embodiments as disclosed herein.

Referring to FIG. 2, the UE 102 is configured to determine an optimal beam belonging to the target gNB-DU 106A, 106B (based on L1 measurements) and apply the corresponding TA.

At step S201, the UE 102 is still connected to the serving gNB-DU 104 (before the LTM Serving cell switch).

At step S202, the UE 102 uses the RRC connection with a gNB-Centralized Unit (CU) (200) and sends L3 RRC measurements to the gNB-CU 200.

At step S203, the gNB-CU 200 decides to prepare inter-gNB-DU LTM candidate cell.

At step S204, the gNB-CU 200 initiates the UE context setup request message to the target gNB-DU 106A, 106B through F1 interface, to prepare an inter-DU LTM candidate cell.

At step S205, the target gNB-DU 106A, 106B acknowledges with UE context setup response message through F1 interface and provides the candidate/target cell configuration.

At step S206, the gNB-CU 200 sends DL RRC message transfer (RRC reconfiguration (LTM target cell configuration)) to the serving gNB-DU 104 through F1 interface.

At step S207, the RRC reconfiguration message is passed to the UE 102. The serving gNB-DU 104 checks the set of RRM criteria (for example: predefined RSRP threshold) set to trigger sending the L1 measurements to the target gNB-DU 106A, 106B.

At step S208, the UE 102 sends L1 measurements of the configured cells to the serving gNB-DU 104.

Based on step S208, at step S209, the serving gNB-DU 104 requests the UE 102 to perform the UL synchronization using the configured PRACH preamble, with one or more target cells.

At step S210, the serving gNB-DU 104 uses the PDCCH order to request the UE 102 to perform the UL sync.

At step S211, the UE 102 performs the UL synchronization and sends the RACH Preamble to the target gNB-DU 106A, 106B cell.

At at step S212, the UE 102 is configured to receive the RAR from the target gNB-DU 106A, 106B which includes the candidate/target cell TA to be used by the UE 102. The target gNB-DU 106A, 106B also transmits multiple neighbouring beams with timing advance to the UE 102 in the RAR.

At step S213, the TA corresponding to multiple beams of the candidate/target cell are available and stored at the UE 102.

At step S214, the UE 102 sends the TAs of the target cell by an Uplink Media Access Control-Control Element (UL MAC CE) to the serving gNB-DU 104.

At step S215, the UE 102 sends intra-frequency L1 Measurement report to the serving gNB-DU 104 after receiving the RAR. In an embodiment, the UE 102 may send L1 MR to the serving gNB-DU 104 for the configured cells.

At step S216, the serving gNB-DU 104 determines the optimal beam of the target cell for the UE 102 using the corresponding TA.

At step S217, the serving gNB-DU 104 sends the optimal beam of the target cell by the MAC CE to the UE 102.

At step S218, the UE 102 sends the RACH-Less HO to the target gNB-DU 106A, 106B cell.

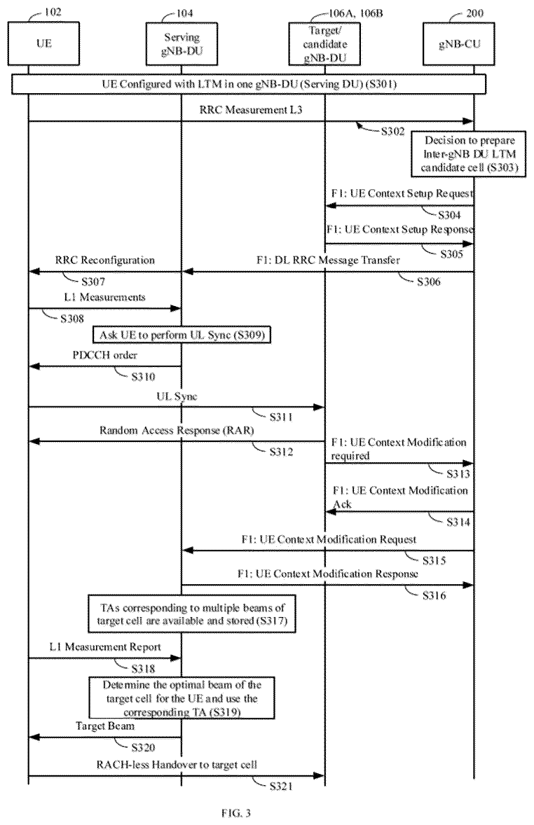

FIG. 3 is a sequence diagram illustrating another scenario in which the UE 102 determines an optimal beam belonging to the target gNB-DU 106A, 106B (based on L1 measurements) and applies the corresponding TA provided by the target gNB-DU 106A, 106B, according to the embodiments as disclosed herein.

Referring to FIG. 3, the UE 102 determines an optimal beam belonging to the target gNB-DU 106A, 106B (based on L1 measurements) and apply the corresponding TA.

At step S301, the UE 102 is still connected to the serving gNB-DU 104 (before the LTM Serving cell switch).

At step S302, the UE 102 uses the RRC connection with the gNB-CU 200 and sends L3 RRC measurements to the gNB-CU 200.

At step S303, the gNB-CU 200 determines to prepare inter-gNB-DU LTM candidate cell.

At step S304, the gNB-CU 200 initiates the UE context setup request message to the target gNB-DU 106A, 106B to prepare an inter-DU LTM candidate cell.

At step S305, the target gNB-DU 106A, 106B acknowledges with UE context setup response message and provides the candidate/target cell configuration.

At step S306, the gNB-CU 200 sends DL RRC message (RRC reconfiguration (LTM target cell configuration)) to the serving gNB-DU 104 through F1 interface.

At step S307, the RRC reconfiguration message is passed to the UE 102. The serving gNB-DU 104 checks the set of RRM criteria (for example: predefined RSRP threshold) set to trigger sending the L1 measurements to the target gNB-DU 106A, 106B.

At step S308, the UE 102 sends L1 measurements of the configured cells to the serving gNB-DU 104.

Based on step S308, at step S309, the serving gNB-DU 104 requests the UE 102 to perform the UL synchronization using the configured PRACH preamble, with one or more target cells.

At step S310, the serving gNB-DU 104 uses the PDCCH order to request the UE 102 to perform the UL sync.

At step S311, the UE 102 performs the UL synchronization and sends the RACH Preamble to the target gNB-DU cell.

At at step S312, the UE 102 is configured to receive the RAR from the target gNB-DU 106A, 106B.

At step S313, the target gNB-DU 106A, 106B initiates a context modification procedure to notify the serving gNB-DU 104 of the candidate/target cell TAs. An indication that the UE context modification is required, is sent to the gNB-CU 200. Such indication includes the candidate/target cell TA to be used by the UE 102. The target gNB-DU 106A, 106B also includes multiple beams with timing advance, in the F1 message.

At step S314, based on the indications described at step S312, the gNB-CU 200 sends an acknowledgment related to the indication that the UE context modification is required.

At step S315, the gNB-CU 200 initiates the UE context modification request message to the serving gNB-DU 104. This includes the candidate/target cell TA to be used by the UE 102. The gNB-CU 200 also includes multiple beams with timing advance sent by target gNB-DU 106A, 106B to the serving gNB-DU 104 in the F1 message.

At step S316, the serving gNB-DU 104 acknowledges with UE context modification request message through F1 interface.

At step S317, the TA corresponding to multiple beams of the target cell are available and stored at the serving gNB-DU 104.

At step S318, the UE 102 sends intra-frequency L1 Measurement report to the serving gNB-DU 104 based on the reception of the RAR.

At step S319, the serving gNB-DU 104 determines the optimal beam of the target cell for the UE 102 and uses the corresponding TA.

At step S320, the serving gNB-DU 104 sends the target beam of the target cell by the MAC CE to the UE 102, based on the determination of the optimal beam.

At step S321, the UE 102 sends the RACH-Less HO to the target gNB-DU 106A, 106B cell.

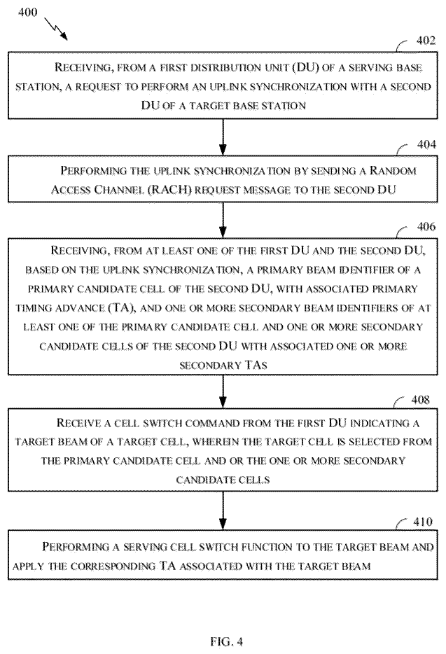

FIG. 4 illustrates a flowchart of a method 400 for wireless communication at a UE, according to the embodiments as disclosed herein.

As illustrated in FIG. 4, method 400 may comprise one or more steps. The method 400 may be described in the general context of computer executable instructions. Generally, computer executable instructions can include routines, programs, objects, components, data structures, procedures, modules, and functions, which perform particular functions or implement particular abstract data types.

The order in which method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 402, the UE 102 may receive a request, from the first distribution unit (DU) of the serving base station 104, to perform an uplink synchronization with the second DU of the target base station 106A, 106B. In an embodiment, the UE 102, prior to receiving from the serving base station 104, the request to perform the uplink synchronization, may transmit, to the serving base station 104, a measurement report (MR) associated with respective one or more signal and channel parameters of a plurality of candidate cells of one or more neighbouring base stations. In an example, the plurality of candidate cells may include a plurality of non-serving cells. In an embodiment, the UE 102 receives the request to perform uplink synchronization using a PDCCH order sent by the serving base station 104.

At step 404, the UE 102 may perform the uplink synchronization by sending a Random Access Channel (RACH) request message to the second DU. In an embodiment, the UE 102 may receive, from the target base station 106A, 106B and in response to performing the uplink synchronization, a Random-Access Response (RAR). For example, the RAR may include at least the primary beam identifier with the associated primary TA, and one or more secondary beam identifiers with one or more associated secondary TAs.

At step 406, the UE 102 may receive one of the first DU and the second DU based on the uplink synchronization, a primary beam identifier of a primary candidate cell of the second DU, with associated primary timing advance (TA), and one or more secondary beam identifiers of at least one of the primary candidate cell and one or more secondary candidate cells of the second DU with associated one or more secondary TAs.

At step 408, the UE 102 may receive a cell switch command from the first DU indicating a target beam of a target cell, wherein the target cell is selected from the primary candidate cell or the one or more secondary candidate cells. In another embodiment the UE 102 may receive a target beam from the primary beam identifier and one or more secondary beam identifiers. In an embodiment, the determination of the target beam may be performed by comparing one or more signal and channel parameters associated with the primary beam identifier with corresponding one or more signal and channel parameters associated with at least one of the secondary beam identifiers. Subsequently, a target beam may be determined from the primary beam identifier and the one or more secondary beam identifiers based on the comparison result. In an example, the one or more secondary beam identifiers are determined based on respective signal quality metrics. For example, a beam may be selected as a secondary beam based on the measurement of the signal quality metrics associated with the beam as compared to other beams present in a beam group.

At step 410, the UE 102 may perform a serving cell switch function to the target beam and apply the corresponding TA associated with the target beam.

In the proposed method, the target gNB-DU 106A, 106B adds the UE's TA of optimal beam in the RAR (optimal beam or the DL beam corresponding to the UL beam that is used by the UE 102 to perform UL synchronization operation). Further, the target gNB-DU 106A, 106B includes the UE's TA of neighbouring beams. Thereby ensuring that in case of any of the neighbouring beams becoming the optimal beam, the UE 102 may dynamically apply the corresponding TA to the optimal beam. Therefore, such dynamic application of the corresponding TA may allow to reduce the overall time taken to perform handover from the serving base station 104 or cell 104 to the target base station 106A, 106B or target cell 106A, 106B. Such dynamic application of the corresponding TA also eliminate the requirement to repeated perform UL synchronization to obtain updated TA due to the UE's mobility.

In an embodiment, the neighbouring beams are qualified as any adjacent beam which may be anticipated to be accessed by the UE 102 subsequently, such as, any beam which the UE 102 is expected to move towards and has optimal channel and signal parameters or characteristics. In an example, the qualification of the neighbouring beams may be interpreted or computed using Artificial Intelligence (AI)-Machine Learning (ML) methods. For example, to determine the qualification of the neighbouring beams a priority list may be generated by the UE 102 or the serving base station 104. In another example, the priority list of the neighbouring beams may be generated at the target base station 106A, 106B.

In an embodiment, the priority list of neighbouring beams may be generated based on a target beam/beam-group selected by UE 102 on one or more previous occasions of handover. In an example, the priority list may be generated based on one or more of beamforming structure being implemented in the cell, total number of neighbouring target beams/beam-groups available from an optimal beam or beam group, or RSRP metrics reported by UE 102 for the different beams/beam-groups. In another embodiment, the number of neighbouring beam TAs may be decided by the gNB-CU 200.

In an embodiment, the serving gNB-DU 104 may indicate the target cell beam to be used by the UE 102, in the SCC command, such as Downlink (DL) MAC CE, sent to the UE 102. The UE 102 may use the TA which is being provided by the target gNB-DU 106A, 106B corresponding to the beam indicated during SCC command.

In another embodiment, the UE 102 is autonomously configured to determine the optimal beam belonging to the target gNB-DU 106A, 106B (based on L1 measurements) and apply the corresponding TA (provided by the target gNB-DU 106A, 106B).

In the proposed method and system, the serving gNB-DU 104 refines the optimal beam to correct for UE mobility and implement better TA estimation. In an embodiment, a receiver architecture associated with a digital beamforming reception is implemented by the proposed method and system. In another embodiment, an analog beamforming reception is implemented by the proposed method and system. The proposed method is used to receive a Physical Random Access Channel (PRACH) signal with multiple receive beams (a set of beams adjacent to each other, list given by the serving cell 104 or chosen by the target cell 106A, 106B) are processed.

With at least one of the receive beams, the target gNB-DU 106A, 106B may compute the TA. In an example, the serving cell 104 may share the TA using the UL MAC CE which includes both beam index of the target cell 106A, 106B and corresponding TA by using the UE 102.

As the UE 102 will have the information of the TAs of neighbouring or secondary beams apart from the information of the TA of the target beam, the UE 102 may be capable of determining if the target beam is the optimal beam to perform the handover. If the UE 102 determines that one of the secondary beams is the optimal beam to perform the handover, the UE 102 can accordingly select the secondary beam and replace with the target beam. In an alternate embodiment, the serving base station 104 may also be configured to compare the target beam with the secondary beams to determine an optimal beam and accordingly transmit the optimal beam information to the UE. Therefore, the UE 102 may be able to perform RACH-less LTM handover with a target base station 106A, 106B with the optimal beam which is valid for an extended time period even when the UE 102 undergoes mobility. For example, when the UE 102 travels from one location to another, thereby causing change in the TA.

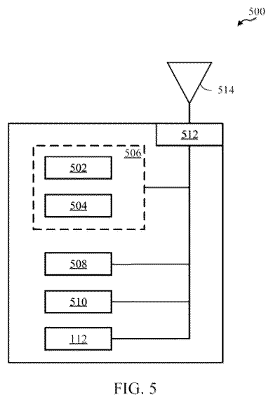

FIG. 5 illustrates a detailed block diagram of an apparatus 500 wherein the method for wireless communication may be implemented. FIG. 5 illustrates a detailed block diagram of an apparatus 500, in accordance with some embodiments of the present disclosure. In one embodiment it will be appreciated that the apparatus 500 is associated with the UE 102. In another embodiment it will be appreciated that the apparatus 500 is associated with the serving base station 104. The apparatus 500 may comprise at least one transmitter 502, at least one receiver 504, at least one processor 508, at least one memory 510, at least one interface 512, and at least one antenna 514. The at least one transmitter 502 may be configured to transmit data/information to one or more nodes/devices using the antenna 514 and the at least one receiver 504 may be configured to receive data/information from the one or more nodes/devices using the antenna 514. The at least one transmitter 502 and receiver 504 may be collectively implemented as a single transceiver module 506. In one non-limiting embodiment, the at least one processor 508 may be communicatively coupled with the transceiver module 506, memory 510, interface 512, and antenna 514 for implementing the above-described technique of processing the wireless communication and specifically performing RACH-less LTM HO.

The at least one processor 508 may include, but not restricted to, one or more of microprocessors, microcomputers, micro-controllers, central processing units, state machines, logic circuitries, and any devices that manipulate signals based on operational instructions. A processor may also be implemented as a combination of computing devices, e.g., a combination of a plurality of microprocessors or any other such configuration. The at least one memory 510 may be communicatively coupled to the at least one processor 508 and may comprise various instructions, the UE signal strength data, the initial bandwidth part, the one or more dedicated bandwidth parts, the pre-defined intervals, and the like. The at least one memory 510 may include one or more of a Random-Access Memory (RAM) unit and a non-volatile memory unit such as a Read Only Memory (ROM), optical disc drive, magnetic disc drive, flash memory, Electrically Erasable Read Only Memory (EEPROM), a memory space on a server or cloud and so forth. The at least one processor 508 may be configured to execute one or more instructions stored in the memory 510.

The interfaces 512 may include a variety of software and hardware interfaces, for example, a web interface, a graphical user interface, an Input Device-Output Device (I/O) interface, a network interface, and the like. The I/O interfaces may allow the apparatus 500 to communicate with one or more nodes/devices either directly or through other devices. The network interface may allow the apparatus 500 to interact with one or more networks either directly or via any other network.

The apparatus 500 may further include the optimal beam determination module 112A, 112B to determine an optimal beam from the primary beam identifier and the one or more secondary beam identifiers based on associated one or more signal and channel parameters and define the optimal beam as the target beam. In an example, the optimal beam is the target beam based on the determination that the current target beam has optimal characteristics as compared to other beam or beam group.

The UE 102, when provided with TAs of the neighbouring beams along with the TA of the target beam, allows the UE 102 to autonomously determine the optimal beam belonging to the target gNB-DU 106A, 106B. For example, the UE 102 may be autonomously configured to consider the channel and signal parameters, such as L1 measurements, to determine the optimal beam belonging to the target gNB-DU 106A, 106B and, subsequently, apply the corresponding TA provided by the target gNB-DU 106A, 106B.

In an embodiment [1], an apparatus is configured to: receive, at a User Equipment (UE) 102 from a first distributed unit (DU) of a serving base station 104, a request to perform an uplink synchronization with a candidate cell of a second DU of a target base station 106A, 106B; perform, at the UE 102, the uplink synchronization by sending a Random Access Channel (RACH) request message to the second DU; receive, from one of the first DU and the second DU and at the UE 102, based on the uplink synchronization, a primary beam identifier of a primary candidate cell of the second DU, with associated primary timing advance (TA), and one or more secondary beam identifiers of at least one of the primary candidate cell and one or more secondary candidate cells of the second DU with associated one or more secondary TAs; receive, at the UE 102, a cell switch command from the first DU indicating a target beam of a target cell, wherein the target cell is selected from the primary candidate cell or the one or more secondary candidate cells; and perform, at the UE 102, a serving cell switch function to the target beam and apply a corresponding TA associated with the target beam.

In an embodiment [2], prior to receiving, from the first DU, the request to perform the uplink synchronization, the apparatus described in the embodiment [1] is configured to: transmit, from the UE 102 and to the first DU, a Layer 1 measurement report (L1 MR) associated with respective one or more signal and channel parameters of a plurality of candidate cells associated with the first DU and one or more DUs associated with one or more neighbouring base stations, wherein the plurality of candidate cells includes a plurality of non-serving cells.

In an embodiment [3], in response to performing the uplink synchronization, the apparatus described in the embodiment [1] is configured to receive, at the UE 102 and from the second DU, a Random Access Response (RAR), wherein the RAR includes at least the primary beam identifier with the associated primary TA, and one or more secondary beam identifiers with one or more associated secondary TAs.

In an embodiment [4], the cell switch command associated with the apparatus described in the embodiment [1] is a Layer 1/Layer 2 Triggered Mobility (LTM) cell switch command.

In an embodiment [5], according to the apparatus described in the embodiment [1], the one or more secondary beam identifiers are determined based on respective signal quality metrics.

In an embodiment [6], according to the apparatus described in the embodiment [1], the request to perform the uplink synchronization is received at the UE 102 using a Physical Downlink Control Channel (PDCCH) order, and wherein the serving base station is the target base station.

In an embodiment [7], a method for wireless communication at a User Equipment (UE) 102 is performed. The method comprising: receiving, from a first distribution unit (DU) of a serving base station 104, a request to perform an uplink synchronization with a second DU of a target base station 106A, 106B; performing the uplink synchronization by sending a Random Access Channel (RACH) request message to the second DU; receiving, from at least one of the first DU and the second DU based on the uplink synchronization, a primary beam identifier of a primary candidate cell of the second DU, with associated primary timing advance (TA), and one or more secondary beam identifiers of at least one of the primary candidate cell and one or more secondary candidate cells of the second DU with associated one or more secondary TAs; receiving a cell switch command from the first DU indicating a target beam of a target cell, wherein the target cell is selected from the primary candidate cell or the one or more secondary candidate cells; and performing a serving cell switch function to the target beam and apply the corresponding TA associated with the target beam.

In an embodiment [8], according to the method described in the embodiment [7], prior to receiving, from the first DU, the request to perform the uplink synchronization, transmitting, to the first DU, a Layer 1 measurement report (L1 MR) associated with respective one or more signal and channel parameters of a plurality of candidate cells associated with the first DU and one or more DUs associated with one or more neighbouring base stations, wherein the plurality of candidate cells includes a plurality of non-serving cells.

In an embodiment [9], the method described in the embodiment [7] further comprises: receiving, from the second DU and in response to performing the uplink synchronization, a Random Access Response (RAR), wherein the RAR includes at least the primary beam identifier with the associated primary TA, and one or more secondary beam identifier with one or more associated secondary TAs.

In an embodiment [10], the method described in the embodiment [7] further comprises: determining the one or more secondary beam identifiers by determining the one or more secondary beam identifiers based on respective signal quality metrics.

In an embodiment [11], according to the method described in the embodiment [7], receiving the request to perform the uplink synchronization include receiving the request to perform the uplink synchronization using a Physical Downlink Control Channel (PDCCH) order, and wherein the serving base station is the target base station.

In an embodiment [12], an apparatus is configured to: determine, at a serving base station 104 and at a first distributed unit (DU) of the serving base station 104, a candidate cell of a target base station 106A, 106B from one or more DUs of one or more candidate base stations, based on one or more signal and channel parameters of a plurality of candidate cells of one or more neighbouring base stations; transmit, from the serving base station 104, a request, to a User Equipment (UE) 102, to perform uplink synchronization with the candidate cell; receive, at the serving base station 104 and from at least one of the UE 102 and a second DU of the target base station 106A, 106B, a primary beam identifier of a primary candidate cell of the second DU with an associated primary timing advance (TA), and one or more secondary beam identifiers of at least one of the primary candidate cell and one or more secondary candidate cells of the second DU with an associated one or more secondary TAs, the primary beam identifier, the primary TA, the one or more secondary beam identifiers, and the one or more secondary TAs being received from the second DU based on the uplink synchronization; determine, at the serving base station 104, a target beam of a target cell from the primary beam identifier and the one or more secondary beam identifiers based on associated one or more signal and channel parameters; and transmit a request, from the serving base station 104, the UE 102 to perform serving cell switch function to the target beam and apply a corresponding TA associated with the target beam.

In an embodiment [13], according to the apparatus described in the embodiment [12], to determine the target beam, the apparatus is configured to: compare, at the serving base station 104, one or more signal and channel parameters associated with the primary beam identifier with corresponding one or more signal and channel parameters associated with each of the one or more secondary beam identifiers; and based on the comparison, determine, at the serving base station 104, the target beam from the primary beam identifier and the one or more secondary beam identifiers.

In an embodiment [14], the apparatus described in the embodiment [12] is further configured to: prior to determining the second DU, receive, at the serving base station 104 and from the UE 102, a Layer 1 measurement report (L1 MR) associated with respective one or more signal and channel parameters of the plurality of candidate cells associated with the first DU and one or more DUs associated with one or more neighbouring base stations, wherein the plurality of candidate cells includes a plurality of non-serving cells.

In an embodiment [15], the apparatus described in the embodiment [12] is configured to transmit, from the serving base station 104, the request to perform the uplink synchronization that comprises a request for a Random Access Channel Request (RACH), to the second DU, wherein the request for the RACH triggers a Random Access Response (RAR) from second DU including at least the primary beam identifier with the associated primary TA, and the one or more secondary beam identifiers with the associated one or more secondary TAs.

In an embodiment [16], according to the apparatus described in the embodiment [14], the serving cell switch function is performed based on a Layer 1/Layer 2 Triggered Mobility (LTM) cell switch command.

In an embodiment [17], the apparatus described in the embodiment [12] determines the one or more secondary beam identifiers based on respective signal quality metrics.

In an embodiment [18], the apparatus described in the embodiment [12] transmits the request to perform the uplink synchronization to the UE (102) using a Physical Downlink Control Channel (PDCCH) order, and wherein the serving base station is the target base station.

In an embodiment [19], a non-transitory computer-readable medium having program instructions stored thereon, executed by an apparatus for wireless communication at a User Equipment (UE) 102, is disclosed. The program instructions may comprise receiving, from a first distribution unit (DU) of a serving base station 104, a request to perform an uplink synchronization with a second DU of a target base station 106A, 106B; performing the uplink synchronization by sending a Random Access Channel (RACH) request message to the second DU; receiving, from one of the first DU and the second DU based on the uplink synchronization, a primary beam identifier of a primary candidate cell of the second DU, with associated primary timing advance (TA), and one or more secondary beam identifiers of at least one of the primary candidate cell and one or more secondary candidate cells of the second DU with associated one or more secondary TAs; receiving a cell switch command from the first DU indicating a target beam of a target cell, wherein the target cell is selected from the primary candidate cell or the one or more secondary candidate cells; and performing a serving cell switch function to the target beam and apply the corresponding TA associated with the target beam.

In an embodiment [20], according to the non-transitory computer-readable medium described in the embodiment [19], the program instructions may comprise determining the target beam comprises: comparing one or more signal and channel parameters associated with the primary beam with corresponding one or more signal and channel parameters associated with each of the one or more secondary beams; and based on the comparison, determining a target beam from the primary beam and the one or more secondary beams.

In an embodiment [21], according to the non-transitory computer-readable medium described in the embodiment [19] the program instructions may comprise: prior to receiving, from the first DU, the request to perform the uplink synchronization, transmitting, to the first DU, a Layer 1 measurement report (L1 MR) associated with respective one or more signal and channel parameters of a plurality of candidate cells associated with the first DU and one or more Dus associated with one or more neighbouring base stations, wherein the plurality of candidate cells includes a plurality of non-serving cells.

In an embodiment [22], according to the non-transitory computer-readable medium described in the embodiment [19] the program instructions may comprise: receiving, from the second DU and in response to performing the uplink synchronization, a Random Access Response (RAR), wherein the RAR includes at least the primary beam identifier with the associated primary TA, and one or more secondary beam identifier with one or more associated secondary TAs.

In an embodiment [23], according to the non-transitory computer-readable medium described in the embodiment [19], the program instructions may comprise determining the one or more secondary beam identifiers by determining the one or more secondary beam identifiers based on respective signal quality metrics.

In an embodiment [24], according to the non-transitory computer-readable medium described in the embodiment [19], the program instructions may comprise receiving the request to perform uplink synchronization include receiving the request to perform uplink synchronization using a PDCCH order. In one non-limiting embodiment, the apparatus 500 may be a part of the serving base station 104, but not limited thereto.

In another non-limiting embodiment, the apparatus 500 may be a part of the UE 102, but not limited thereto.

In a non-limiting embodiment of the present disclosure, one or more non-transitory computer-readable media may be utilized for implementing the embodiments consistent with the present disclosure. A computer-readable medium refers to any type of physical memory (such as the memory 510) on which information or data readable by a processor may be stored. Thus, a computer-readable media may store one or more instructions for execution by the at least one processor 508, including instructions for causing the at least one processor 508 to perform steps or stages consistent with the embodiments described herein. The term “computer-readable media” should be understood to include tangible items and exclude carrier waves and transient signals. By way of example, and not limitation, such computer-readable media can comprise Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

Thus, certain aspects may comprise a computer program product for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

The various illustrative logical blocks, modules, and operations described in connection with the present disclosure may be implemented or performed with a general-purpose processor, discrete gate or transistor logic, discrete hardware components or any combination thereof designed to perform the functions described herein. A general-purpose processor may include a microprocessor, but in the alternative, the processor may include any commercially available processor, controller, microcontroller, or state machine. A processor may also be implemented as a combination of computing devices, e.g., a plurality of microprocessors, or any other such configuration.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We claim:

1. An apparatus configured to:
receive, at a User Equipment (UE) (102) from a first distributed unit (DU) of a serving base station (104), a request to perform an uplink synchronization with a candidate cell of a second DU of a target base station (106A, 106B);
perform, at the UE (102), the uplink synchronization by sending a Random Access Channel (RACH) request message to the second DU;
receive, from at least one of the first DU and the second DU and at the UE (102), based on the uplink synchronization, a primary beam identifier of a primary candidate cell of the second DU, with associated primary timing advance (TA), and one or more secondary beam identifiers of at least one of the primary candidate cell and one or more secondary candidate cells of the second DU with associated one or more secondary TAs;
receive, at the UE (102), a cell switch command from the first DU indicating a target beam of a target cell, wherein the target cell is selected from the primary candidate cell or the one or more secondary candidate cells; and
perform, at the UE (102), a serving cell switch function to the target beam and apply a corresponding TA associated with the target beam.

2. The apparatus of claim 1, wherein prior to receiving, from the first DU, the request to perform the uplink synchronization, the apparatus is configured to transmit, from the UE (102) and to the first DU, a Layer 1 measurement report (L1 MR) associated with respective one or more signal and channel parameters of a plurality of candidate cells associated with the first DU and one or more DUs associated with one or more neighbouring base stations, wherein the plurality of candidate cells includes a plurality of non-serving cells.

3. The apparatus of claim 1, wherein, in response to performing the uplink synchronization, the apparatus is configured to:
receive, at the UE (102) and from the second DU, a Random Access Response (RAR), wherein the RAR includes at least the primary beam identifier with the associated primary TA, and one or more secondary beam identifiers with one or more associated secondary TAs.

4. The apparatus of claim 1, wherein the cell switch command is a Layer 1/Layer 2 Triggered Mobility (LTM) cell switch command.

5. The apparatus of claim 1, wherein the one or more secondary beam identifiers are determined based on respective signal quality metrics.

6. The apparatus of claim 1, wherein the request to perform the uplink synchronization is received at the UE (102) using a Physical Downlink Control Channel (PDCCH) order, and wherein the serving base station is the target base station.

7. A method comprising:
receiving, from a first distribution unit (DU) of a serving base station (104), a request to perform an uplink synchronization with a second DU of a target base station (106A, 106B);
performing the uplink synchronization by sending a Random Access Channel (RACH) request message to the second DU;
receiving, from at least one of the first DU and the second DU based on the uplink synchronization, a primary beam identifier of a primary candidate cell of the second DU, with associated primary timing advance (TA), and one or more secondary beam identifiers of at least one of the primary candidate cell and one or more secondary candidate cells of the second DU with associated one or more secondary TAs;
receiving a cell switch command from the first DU indicating a target beam of a target cell, wherein the target cell is selected from the primary candidate cell or the one or more secondary candidate cells; and
performing a serving cell switch function to the target beam and apply the corresponding TA associated with the target beam.

8. The method of claim 7, wherein the method further comprises:
prior to receiving, from the first DU, the request to perform the uplink synchronization, transmitting, to the first DU, a Layer 1 measurement report (L1 MR) associated with respective one or more signal and channel parameters of a plurality of candidate cells associated with the first DU and one or more DUs associated with one or more neighbouring base stations, wherein the plurality of candidate cells includes a plurality of non-serving cells.

9. The method of claim 7, wherein the method further comprises:
receiving, from the second DU and in response to performing the uplink synchronization, a Random Access Response (RAR), wherein the RAR includes at least the primary beam identifier with the associated primary TA, and one or more secondary beam identifier with one or more associated secondary TAs.

10. The method of claim 7, wherein the method comprises determining the one or more secondary beam identifiers by determining the one or more secondary beam identifiers based on respective signal quality metrics.

11. The method of claim 7, wherein receiving the request to perform the uplink synchronization include receiving the request to perform the uplink synchronization using a Physical Downlink Control Channel (PDCCH) order, and wherein the serving base station is the target base station.

12. An apparatus configured to:
determine, at a serving base station (104) and at a first distributed unit (DU) of the serving base station (104), a candidate cell of a target base station (106A, 106B) from one or more DUs of one or more candidate base stations, based on one or more signal and channel parameters of a plurality of candidate cells of one or more neighbouring base stations;
transmit, from the serving base station (104), a request, to a User Equipment (UE) (102), to perform uplink synchronization with the candidate cell;
receive, at the serving base station (104) and from at least one of the UE (102) and a second DU of the target base station (106A, 106B), a primary beam identifier of a primary candidate cell of the second DU with an associated primary timing advance (TA), and one or more secondary beam identifiers of at least one of the primary candidate cell and one or more secondary candidate cells of the second DU with an associated one or more secondary TAs, the primary beam identifier, the primary TA, the one or more secondary beam identifiers, and the one or more secondary TAs being received from the second DU based on the uplink synchronization;
determine, at the serving base station (104), a target beam of a target cell from the primary beam identifier and the one or more secondary beam identifiers based on associated one or more signal and channel parameters; and
transmit a request, from the serving base station (104) and to the UE (102) to perform serving cell switch function to the target beam and apply a corresponding TA associated with the target beam.

13. The apparatus of claim 12, wherein, to determine the target beam, the apparatus is configured to:
compare, at the serving base station (104), one or more signal and channel parameters associated with the primary beam identifier with corresponding one or more signal and channel parameters associated with each of the one or more secondary beam identifiers; and
based on the comparison, determine, at the serving base station (104), the target beam from the primary beam identifier and the one or more secondary beam identifiers.

14. The apparatus of claim 12, wherein the apparatus is further configured to:
prior to determining the second DU, receive, at the serving base station (104) and from the UE (102), a Layer 1 measurement report (L1 MR) associated with respective one or more signal and channel parameters of the plurality of candidate cells associated with the first DU and one or more DUs associated with one or more neighbouring base stations, wherein the plurality of candidate cells includes a plurality of non-serving cells.

15. The apparatus of claim 12, wherein the apparatus is configured to transmit, from the serving base station (104), the request to perform the uplink synchronization that comprises a request for a Random Access Channel Request (RACH), to the second DU, wherein the request for the RACH triggers a Random Access Response (RAR) from second DU including at least the primary beam identifier with the associated primary TA, and the one or more secondary beam identifiers with the associated one or more secondary TAs.

16. The apparatus of claim 12, wherein the serving cell switch function is performed based on a Layer 1/Layer 2 Triggered Mobility (LTM) cell switch command.

17. The apparatus of claim 12, wherein the apparatus determines the one or more secondary beam identifiers based on respective signal quality metrics.

18. The apparatus of claim 12, wherein the apparatus transmits the request to perform the uplink synchronization to the UE (102) using a Physical Downlink Control Channel (PDCCH) order, and wherein the serving base station is the target base station.
